(19) United States
(12) Patent Application Publication
(10) Pub. No.: US 2011/0084541 A1
(43) Pub. Date: Apr. 14, 2011

(54) Tri-Flange Hub

(75) Inventor: Paul Eric Lew, Las Vegas, NV (US)

(73) Assignee: Reynolds Cycling LLC, West Jordan, UT (US)

(21) Appl. No.: 12/908,867

(22) Filed: Oct. 20, 2010

Related U.S. Application Data
(63) Continuation-in-part of application No. 12/455,393, filed on May 30, 2009, now abandoned.

(51) Int. Cl. B60B 1/02; B60B 1/04; B60B 19/00; B60B 1/06; B60B 27/00

(52) U.S. Cl. 301/6.5; 301/55; 301/56; 301/62; 301/59; 301/110.5

(57) ABSTRACT

A bicycle wheel with a tri-flange hub includes a hub with a first flange, second flange, and a third flange. The rim of the bicycle wheel is connected to the first, second and third flanges by spokes. The third flange is located on the hub along a centerline which passes through the center of the rim.

### RELATED DOCUMENTS

The present application is a continuation-in-part, and claims the benefit under 35 U.S.C. §120, of U.S. application Ser. No. 12/455,393, entitled “Wheel with Composite Rim,” filed May 30, 2009. This application is herein incorporated by reference in its entirety.

### BACKGROUND

Bicycle wheels include a hub, a rim, a number of spokes which extend from the hub to the rim, and a tire mounted on the rim. The hubs are the connection points between the bicycle wheels and the bicycle frame. The spokes are configured to attach the hub to the rim. During cycling, a rider creates torque which is applied at the rear hub of the bicycle. The rear hub distributes this force to the spokes which connect the rear hub to the rim. The spokes transfer the torque applied to the hub to the rim and tire. Contact between the rotating tire and the road results in linear motion of the bicycle.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIGS. 1A-1B are diagrams of an illustrative front bicycle wheel, according to one example of principles described herein.

FIG. 2A-2B are diagrams of an illustrative rear bicycle wheel, according to one example of principles described herein.

FIGS. 3A-3D are diagrams of an illustrative rear bicycle wheel, according to one example of principles described herein.

FIG. 4 is a diagram of a modular tri-flange hub, according to one example of principles described herein.

Throughout the drawings, identical reference numbers designate similar, but not necessarily identical, elements.

### DETAILED DESCRIPTION

A bicycle wheel is a dynamic system which performs a number of functions. Bicycle wheels typically include a hub, a rim, a number of spokes which extend from the hub to the rim, and a tire mounted on the rim. The hubs are the connection points between the bicycle wheels and the bicycle frame. The bicycle wheels are designed to withstand a variety of forces, including forces generate during acceleration, braking, impacting obstacles in the road, and cornering. The mechanical and aerodynamic characteristics of the bicycle wheels have a significant influence on the safety and handling of the bicycle.

During cycling, a rider creates torque which is applied at the rear hub of the bicycle. The rear hub distributes this force to the spokes which connect the hub to the rim. The spokes transfer the torque applied to the hub to the rim and tire. The torque on the tire is transferred to the road, resulting linear motion of the bicycle.

The torsional stiffness of a bicycle wheel is a measurement of the mechanical rigidity wheel when a torque is applied at the hub. The torsional stiffness of a wheel is at least partly determined by the spoke design and configuration. Bicycle wheels with high torsional stiffness are desirable for crisp acceleration and responsive handling. However, torsional stiffness is only one design factor and must be balanced against other design factors such as wheel mass, aerodynamics, and rotational inertia.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

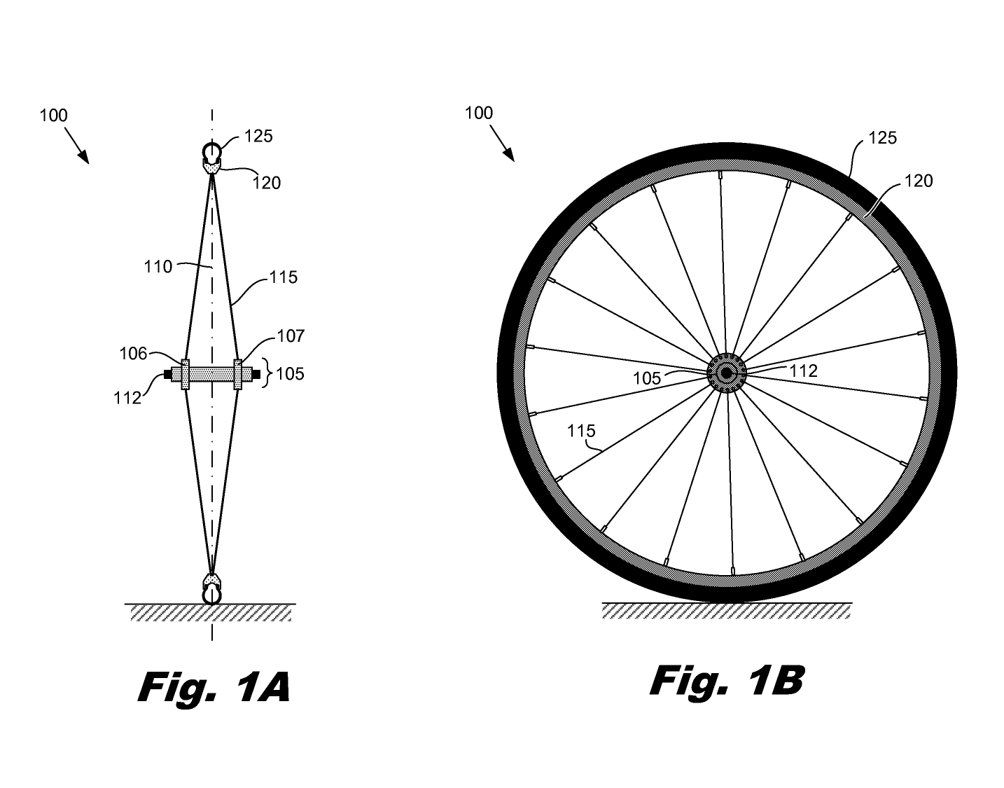

FIGS. 1A-1B are diagrams of an illustrative front bicycle wheel (100). FIG. 1A is a cross sectional diagram of the front bicycle wheel (100) and FIG. 1B is a side view of the front bicycle wheel (100). The front wheel (100) includes a hub (105) with a left flange (106) and a right flange (107). Spokes (115) are attached between the flanges (106, 107) and the rim (120). A tire (125) is mounted to the rim (120). Each of these components is symmetrically arranged about a centerline (110) which passes through the center of the hub (105), rim (120), and tire (125).

In conventional bicycles, the front wheel (100) is not powered. The front wheel (100) is used for steering, braking, and to support the weight of the front of the bike and rider. However, no torque is applied to the hub (105) of the front wheel (100). The hub (105) is free at all times to rotate about an axle (112) which passes through the hub (105). Because there is no torque applied to the front hub (105), the torsional stiffness of the front wheel is not a significant design issue. Consequently, the hub and spoke design of the front wheel (100) is primarily configured to resist radial and lateral forces. Examples of radial forces include weight or linear acceleration of the bike and rider. Examples of lateral forces include cornering forces which are generated during turns.

The design of the spokes (115) and hub (105) of the front wheel (100) reflect this focus on the radial and lateral stiffness. As shown in FIG. 1B, the spokes (115) extend radially outward from the flanges (106, 107) to the rim (120). The spokes (115) are evenly distributed about the flanges (106, 107) and rim (120). This design is very effective in resisting radial forces. Any force which attempts to move the hub from the center of the rim is resisted by the radial spokes. For example, if a downward force (such as the weight of rider) is applied to the hub, the tension in spokes above the hub increases to resist the downward force. Similarly, the symmetrical non-vertical angles of the spokes (as shown in FIG. 1A) allow the spokes (115) to resist lateral forces which are applied to the hub (105) or tire (125).

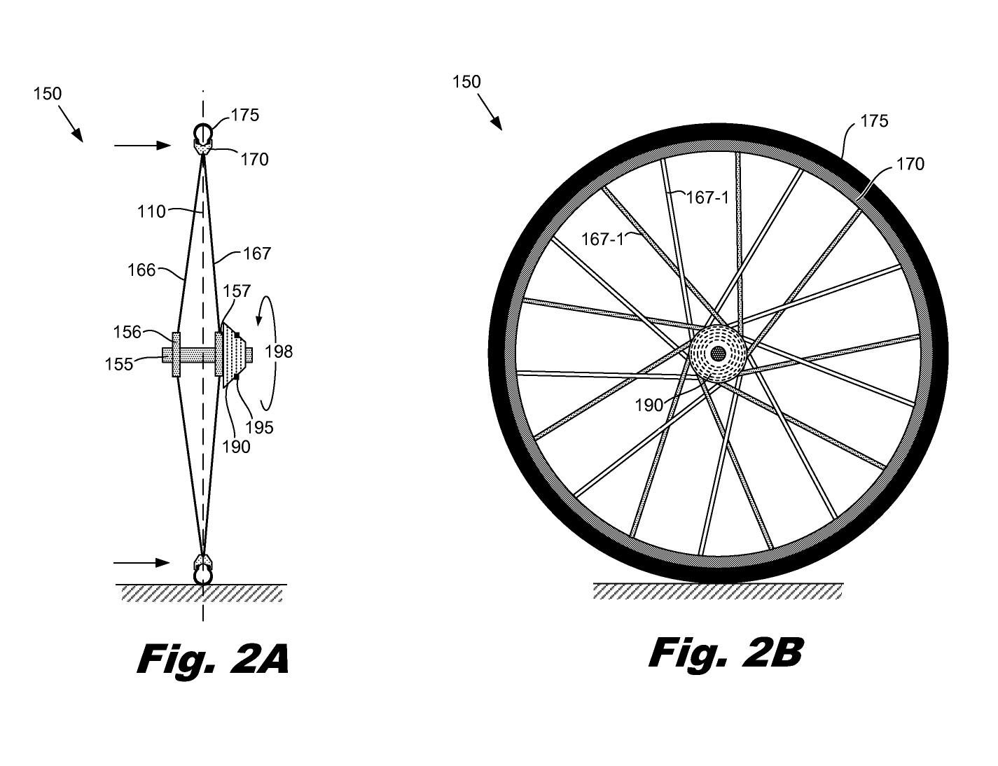

FIG. 2A-2B are diagrams of an illustrative rear bicycle wheel (150). FIG. 2A is a cross sectional diagram of the rear bicycle wheel (150) and FIG. 1B is a side view of the rear bicycle wheel (150). The rear wheel (150) includes a hub (155) with a left flange (156) and a right flange (157). Spokes (166, 167) are attached between the flanges (156, 157) and the rim (170). A tire (175) is mounted to the rim (170). A number of gears (190) are attached to one side of the hub (155). A chain (195) connects the gears (190) to the pedals the pedals. To accommodate the presence of gears (190), the hub flanges (156, 157) and spokes (166, 167) are not symmetrical. The left flange (156) is farther from the centerline (110) than the right flange (157). Consequently, the left spokes (166) which extend from the left flange (156) to the rim (170) are at a greater non-vertical angle than the right spokes (157). For example, the left spokes (166) may be at a 7 degree angle with respect to the centerline (110) and the right spokes (167) may be at a 3 degree angle with respect to the centerline (110).

In conventional bicycles, the rear wheel is powered through the application of torque to the hub by the gears. The term “rear wheel” is used for convenience in describing the illustrative systems and methods. However, the principles described herein could be applied to a variety of powered wheels. For example, in a tricycle or recumbent bicycle, the front wheel may be powered.

Like the front wheel (100, FIG. 1B), the rear wheel (or other powered wheel) is used to support the weight of the bike and rider and for braking. Additionally, the rear wheel (150) is also part of the power chain which transforms the pressure exerted on the pedals by the rider into forward motion. To do this, the rear wheel (150) transmits torque applied on gears (190) through the hub (155) and spokes (166, 167) to the rim and tire. This torque causes wheel (150) to rotate. The contact of the tire (175) with the road converts the rotation into linear motion. Consequently, the torsional stiffness of the rear wheel (150) is a significant factor in the responsiveness of the bicycle to during acceleration.

Because the torque (198) is transmitted through the flanges (156, 157) and spokes (166, 167) of the rear wheel (150), the hub and spoke design is different than the front wheel (100, FIGS. 1A-1B). As discussed above, the radial spoke pattern of the front wheel (100, FIGS. 1A-1B) is very efficient in resisting radial and lateral forces. However, the purely radial spoke pattern of the front wheel (100, FIGS. 1A-1B) does not effectively transmit torque. The rear wheel hub and spoke design is configured to transmit torque as well as resist radial and lateral forces.

As shown in FIG. 2B, the rear hub (155) may have larger flanges (156, 157) than the flanges on the front wheel (100, FIGS. 1A-1B). Additionally, the spokes (166, 167) in the rear wheel (150) are positioned at a tangential angle with respect to flanges (156, 157) in the rear hub (155). For clarity, FIG. 2B shows only the spokes (167) which attach to the right flange (157). A first group of spokes (167-1) extend from the rear hub (155) at a first tangential angle and a second group of spokes (167-2) extend from the rear hub (155) at a complementary second tangential angle. These two groups of spokes (167-1, 167-2) cross over each other to form an interleaved pattern. The spokes (166) which attach to the left flange (156) are configured in a similar manner. The larger diameter of the flanges (156, 157) and tangential angle of the spokes (166, 167) combine to form a lever arm through which the torsional force (198) can be transmitted without substantial deflection of the spokes (166, 167). This significantly increases the torsional stiffness of the rear bicycle wheel (150).

However, as torque (198) is applied through the hub (155) and spokes (166, 167), the lack of symmetry in the non-vertical angles of the spokes (166, 167) causes tension in the more vertical spokes (in this case the right spokes (167)) to increase more than the other spokes (166). Consequently, during acceleration of the bicycle, the rim (170) and tire (175) to deflect to the right as shown by the horizontal arrows near the top and bottom of the wheel (150). The inventors have recognized that this tendency of the wheel to dish or cup under torque as a significant design issue for powered wheels.

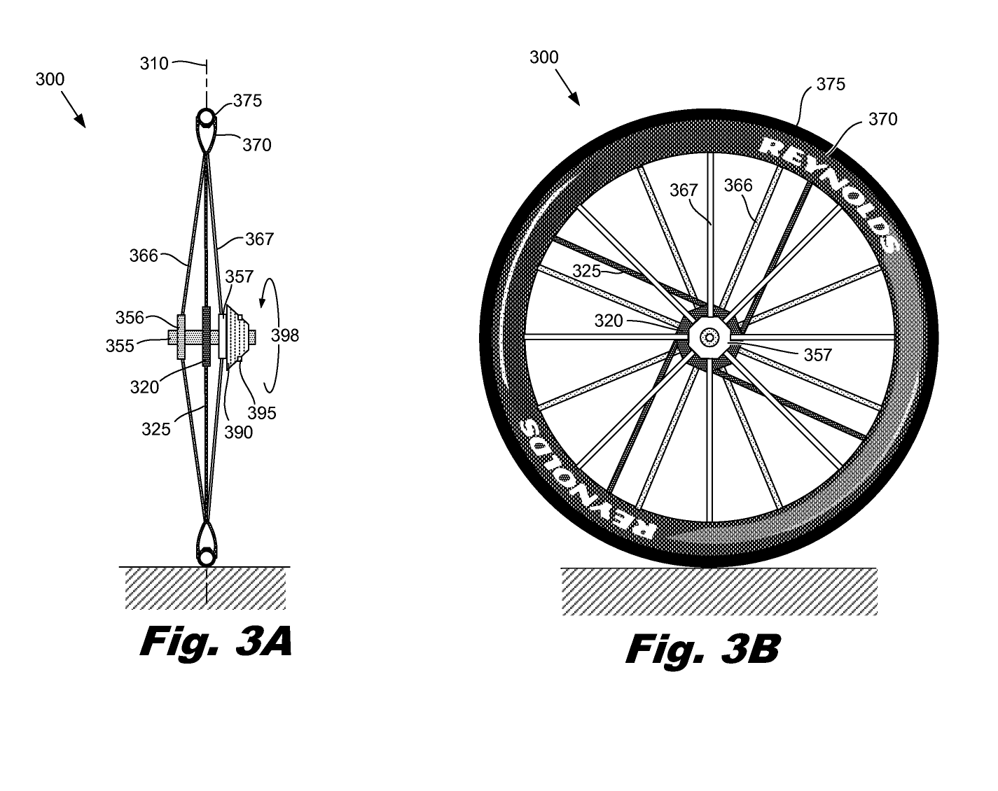

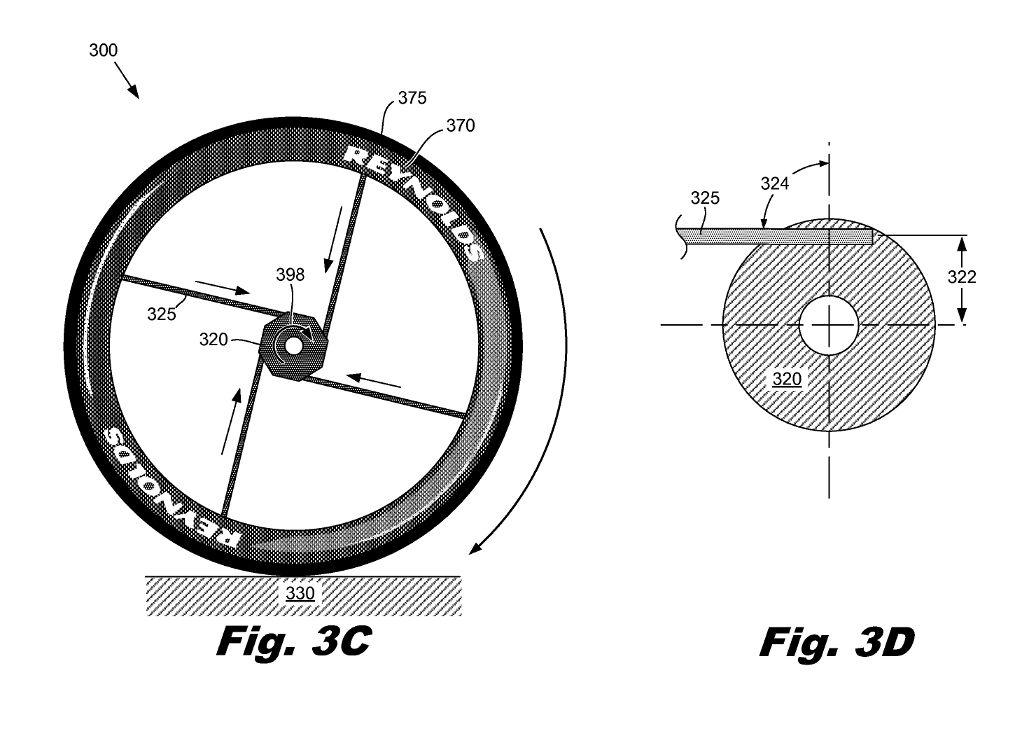

FIGS. 3A-3B are diagrams of an illustrative rear bicycle wheel (300) which incorporates a third center flange (320) in the hub (355). As shown in FIG. 3A, the spokes (366, 367) which attach to the left and right flanges (356, 357) are at different non-vertical angles. FIG. 3B shows that these spokes (366, 367) pass radially from the left and right flanges (356, 357) to the rim (370). As used in the specification and appended claims, the term “radial” or “radially,” when applied to spokes, is used to describe spokes that designed to be connected between a hub and a rim along a straight line which passes through the center of the hub and intersects the rim at a perpendicular angle. The definition of “radial” is broadly used to include manufacturing variations, loading distortion, and other variations which may cause a spoke to deviate from the intended radial configuration.

Because the spokes (366, 367) attached to the left and right flanges (356, 357) are in a purely radial configuration, they have no lever arm through which significant amounts of torque can be transferred from the hub (355) to the rim (370). Attempts to transmit torque through these spokes (366, 367) alone would result in deflection or bending of the spokes (366, 367) from their radial positions.

The center flange (320) is located along the centerline (310) of the wheel (300). As used in the specification and appended claims, the term “centerline,” when used to describe the location of the center flange (320) refers to a diametrical line in a plane which passes through the rim along its cross sectional center. The description of the center flange (320) and tangential spokes (325) as being located on or along the “centerline” is broadly used to include manufacturing variations, loading distortion, and other variations which may cause some deviation from the intended configuration.

In this illustrative embodiment, the center flange (320) is larger than the left and right flanges (356, 357). Attached to the center flange (320) are four tangential spokes (325). As shown in FIGS. 3C and 3D, the center flange (320) and tangential spokes (325) are specifically designed to transmit torque from the hub (355) to the rim (370). For purposes of illustration, only the center flange (320) and tangential spokes (325) are shown in FIG. 3C. The tangential spokes (325) are attached to the center flange (320) tangentially to the outside edge of the center flange (320). As used in the specification and appended claims, the term “tangential” or “tangentially” is used to describe spokes that are connected between a hub and a rim at a substantially non-radial angle. For example, a line passing through a tangential spoke (325) has an offset (322) from the center of flange (320) and intersects the rim (370) at a non-perpendicular angle.

When a torque (398) is applied to the central flange (320) in the specified direction, the tangential spokes (325) are placed in tension as shown by the arrows next to the spokes (325). When a torque of the opposite sense is applied to the central flange (320), the spokes (325) would be placed in compression. The offset distance (322) between the center of the flange (320) acts as a lever arm through which the torque (398) can be transmitted to the rim (370) and tire (375). As described above, this results in the rotation of the wheel (300) as it contacts the road (330) and the forward motion of the bicycle.

In rim braking bicycles, the acceleration torque is the primary force which applied to the hub (355). Acceleration torque is generated by the force the rider exerts on the pedals and is applied in only one rotational orientation. Rim braking does not produce a substantial torque on the hub because the braking force is applied to the rim by the brake pads and then transmitted through the rim and tire to the road. Depending on the differences between the tensile and compressive stiffness of the spokes (325), the torsional stiffness of the wheel (300) may be different for one rotational orientation of torque than for the opposite orientation. For example, for the configuration shown in FIG. 3C, the spokes may be stiffer in tension than compression. This results in the wheel having a higher torsional stiffness for clockwise torques. This characteristic may be leveraged designing the wheel so that the primary torque exerted on the wheel (the acceleration torque) is applied in a clockwise orientation. For bicycles which use hub braking, the configuration of the spokes could be more symmetrical to withstand substantial clockwise and counterclockwise torques.

The design of this illustrative wheel (300) eliminates the tendency of the wheel to cup or dish when torque (398) is applied to hub (355) by separating the spokes into two groups: tangential spokes (325) which are primarily configured to transmit torque and radial spokes (366, 367) which are configured to support the bicycle and rider by resisting applied lateral and radial forces. In this example, substantially all of the torque is transmitted through the center flange (320) and tangential spokes (325). Because the center flange (320) and tangential spokes (325) are located along the centerline (310) of the wheel (300), there is no net force on the rim (370) and tire (375) to the left or right when torque (398) is applied to the hub (355). The left and right spokes (366, 367) are in a radial configuration and provide additional lateral and radial stiffness to the wheel (300) but do not transmit any substantial amount of torque to the rim (370).

In this example, there are eight spokes (366) attached to the left flange (356), eight spokes (367) attached to the right flange (357), and four spokes (325) attached to the center flange (320). However, the number of spokes attached to a given flange may be greater or less than the configuration illustrated in FIGS. 3A-3D. For example, the center flange (320) may be connected to the rim (370) by one spoke, two spokes, three spokes, four spokes or more. The size and rigidity of the individual spokes can be adjusted to provide the desired connection characteristics between the hub and the rim. Additionally, there may be more spokes on one side of the wheel than the other or the spokes connected to one flange may be different than the spokes used on another flange.

A wide variety of spokes may be used in the tri-flange design illustrated in FIGS. 3A-3D. For example, the spokes (366, 325, 367) may be formed from metal wire, composite, or other material. Where metal wire spokes are used, the metal wire spokes may be pretensioned during assembly and balancing of the wheel (300). Pretensioning is used because small cross section metal wire spokes are much stiffer in tension than in compression. Consequently, the metal wire spokes are pretensioned during assembly and remain in tension during normal cycling.

According to one illustrative embodiment, the spokes may be formed from composite materials such as carbon, boron, glass, or other materials. Composite spokes may be designed to exhibit both high tensile stiffness and high compressive stiffness. Consequently, in some designs, the composite spokes are not pretensioned during assembly and balancing of the wheel. When there are no external stresses applied to the wheel, there are no substantial structural stresses within the composite spokes. When external forces are applied to the wheel, corresponding tensile or compressive stresses are generated within the spokes to resist the external forces.

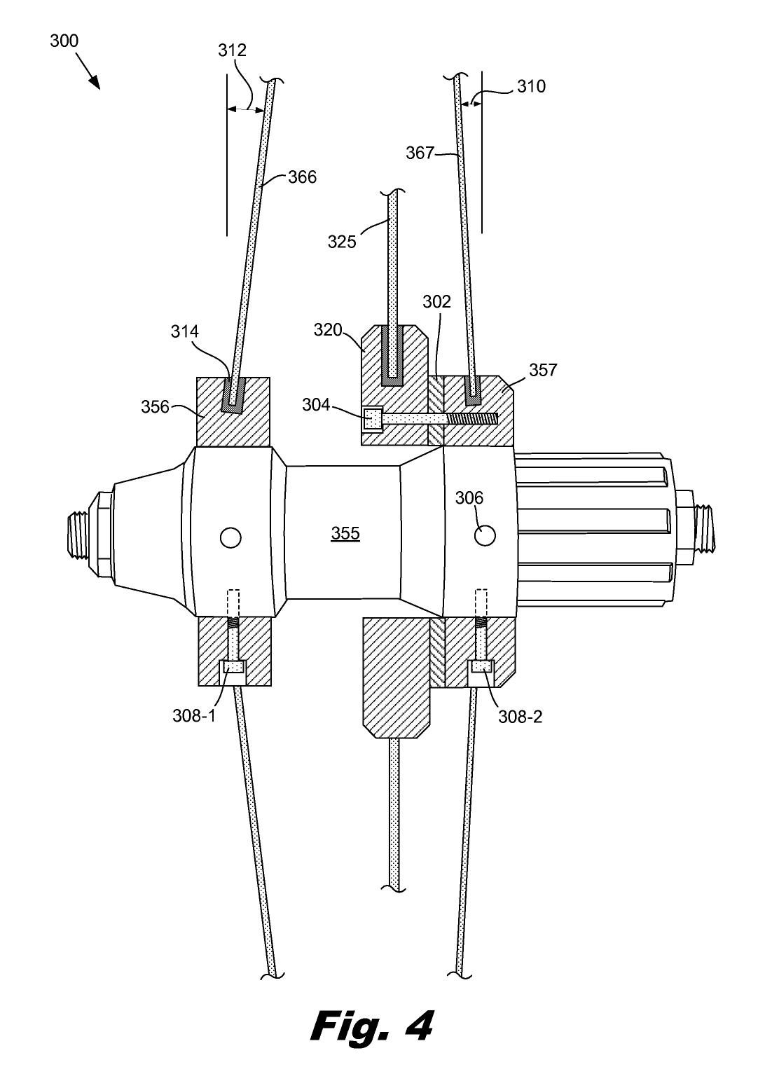

FIG. 4 is a partially cut away diagram of a modular tri-flange hub (300) that includes a central portion (355) and cross sectional diagrams of bolt-on flanges (356, 357, 320). The central portion (355) may include an axle, bearings, a spline for attaching the gears, attachment points for the bicycle frame and other components. In this embodiment, the central portion (355) includes tapped holes (306) around its perimeter. These tapped holes (306) are used to attach the bolt-on flanges (356, 357).

The left and right flanges (356, 357) are attached around the perimeter of the central portion (355) using bolts (308) which thread into the tapped holes (306). The bolted connection is used only as one example of an attachment which allows the flanges (356, 357) to be detached and reconnected to central portion (355) of the hub. A variety of other configurations could be used, including adhesives, geometrically interlocking features, set screws, latches or other connection mechanisms.

In this example, the third central flange (320) is not directly connected to the central portion (355) but is bolted to the right flange (357) using bolts (340). As discussed above, the central flange (320) is in line with the centerline of the wheel which passes through the center of the rim and intersects and is perpendicular to the wheel axle. To obtain the desired offset from the right flange (357) to the centerline, a shim (302) may be placed between the central flange (320) and the right flange (357).

According to one illustrative embodiment, the flanges (320, 356, 357) may be formed from metal, with the composite spokes (325, 366, 367) potted into cavities (314) in the flanges. A variety of other configurations could also be used. As discussed above, the spokes (366, 367) are attached to the left and right flanges (356, 357) at non-vertical angles (310, 312). As used in the specification and appended claims, the term “non-vertical angles” refers to angles which are not parallel to a plane passing through the center of the rim and tire. In this embodiment, the spokes (325) attached to the third flange (320) are at a vertical angle and lie in the plane passing through the center of the rim and tire.

The configuration illustrated in FIG. 4 is only one illustrative example of a modular tri-flange hub. A number of other configurations could be used. For example, the right flange (357), shim (302) and central flange (320) could be formed from a single piece of metal or other material. Additionally, some or all of the composite spokes (325, 366, 367) could be replaced by metal spokes.

In conclusion, the tri-flange hub described above has a number of advantages. The tri flange hub separates the torque transmission function of the hub and spokes from the support function. The left and right flanges and spokes are configured to serve the support function and to transmit little, if any, torque. The central flange and tangential spokes are configured to be the primary mechanism for transmitting torque from the hub to the rim. Because the central flange is inline with the rim and tire, the tendency for the wheel to distort due to applied torque is reduced or eliminated.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A bicycle wheel with a tri-flange hub comprising:
a hub comprising:
a first flange;
a second flange;
a third flange;
a rim; and
spokes connecting the first, second, and third flanges to the rim;
in which the third flange is located on the hub along a centerline which passes through the center of the rim.

2. The wheel of claim 1, in which the wheel is a driven wheel.

3. The wheel of claim 1, in which the wheel is a rear wheel of a bicycle.

4. The wheel of claim 1, in which spokes connecting the first and second flanges to the rim have a radial orientation.

5. The wheel of claim 1, in which spokes connecting the third flange to the rim attach to the third flange at a tangential angle and intersect with the rim at a non-perpendicular angle.

6. The wheel of claim 5, in which spokes connecting the third flange to the rim are radially offset from the center of the third flange to create a lever arm.

7. The wheel of claim 1, further comprising driven gears applying a torque to the hub.

8. The wheel of claim 7, in which the third flange is configured to transmit substantially all of the torque applied to the hub to the rim and the first flange and the second flange are configured to provide additional lateral and radial wheel stiffness.

9. The wheel of claim 8, in which spokes connecting the first flange to the rim are at a first non-vertical angle; and the spokes connecting the second flange to the rim are at a second and different non-vertical angle.

10. The wheel of claim 1, in which the hub further comprises a center portion, in which the first second and second flanges are removably attached to the center portion.

11. The wheel of claim 10, in which the first and second flanges directly attach to the center portion and the third flange attaches to one of the first and second flanges.

12. The wheel of claim 11, in which the third flange is offset from one of the first and second flanges by a shim.

13. The wheel of claim 1, in which the rim and spokes are formed from composite material.

14. The wheel of claim 1, in which the spokes comprise carbon boron composite.

15. The wheel of claim 1, in which the spokes are not pretensioned.

16. The wheel of claim 1, in which the first, second, and third flanges are metal flanges and the spokes are composite spokes, the composite spokes being adhered to the metal flanges.

17. The wheel of claim 1, in which the third flange has a larger diameter than the first and second flanges.

18. The wheel of claim 1, in which the spokes are metal spokes which are pretensioned between the flanges and the rim.

19. A rear bicycle wheel comprising:
a hub;
a rim; and
a plurality of spokes connecting the hub to the rim, in which a predetermined first subset of the spokes are vertically oriented along the centerline of the rim and are configured to transmit torsional force from the hub to the rim; and a predetermined second subset of the spokes oriented at non-vertical angles and pass radially between the hub and the rim.

20. A modular tri-flange hub comprising:
a central portion;
a first flange bolted to the central portion;
a second flange bolted to the central portion;
a third flange attached to one of the first flange and the second flange, the third flange being aligned with the cross sectional centerline of a rim attached to the hub, the third flange being connected to the rim by offset tangential spokes such that a substantial portion of torque applied to the hub is transmitted through the third flange and offset tangential spokes to the rim.
